(19) United States
(12) Patent Application Publication
(10) Pub. No.: US 2002/0028352 A1
(43) Pub. Date: Mar. 7, 2002

(54) Magnetic Recording Medium

(76) Inventors: Kazuo Kato, Kanagawa (JP); Hiroaki Doushita, Kanagawa (JP)

Correspondence Address: Stroock & Stroock & Lavan LLP, 180 Maiden Lane, New York, NY, 10038, US

(21) Appl. No.: 09/858,266

(22) Filed: May 15, 2001

(30) Foreign Application Priority Data
May 16, 2000 (JP) 2000-143343

(51) Int. Cl. G11B 5/714

(52) U.S. Cl. 428/694 BS

(57) ABSTRACT

A magnetic recording medium for high-density recording having good electromagnetic characteristics and good running durability is provided. A magnetic recording medium which comprises a lower layer comprising a nonmagnetic powder and a binder and a magnetic layer comprising a ferromagnetic powder and a binder provided in this order on a nonmagnetic support, wherein said ferromagnetic powder is a metal ferromagnetic powder with a mean major axis length equal to or less than 0.1 μm, the average thickness of said magnetic layer ranges from 0.01 to 0.1 μm, and the surface lubricant index is 1.1-2.4.

### FIELD OF THE INVENTION

The present invention relates to a magnetic recording medium for high-density recording.

### BACKGROUND OF THE INVENTION

In the field of magnetic tapes, as personal computers, work stations, and other office computers have become widespread in recent years, magnetic tapes (called “backup tapes”) for recording computer data have become widespread as an external memory medium. As the technology has progressed, computers have grown smaller and there has been a marked increase in information processing capacity, so there is a strong demand for the development of high recording density and high recording capacity backup tapes.

The magnetic tapes employed in computer backup systems are determined by the system; there are known magnetic tapes corresponding to DLT type, 3480, 3490, 3590, QIC, D8 type, and DDS type systems. In the magnetic tapes employed in these systems, a magnetic layer comprising a ferromagnetic powder, binder, and abrasive of single-layer structure with a relatively thick film thickness of 2.0-3.0 μm is provided on one side of a support, and a backcoat layer for preventing tangled winding and ensuring good running durability is provided on the other side. However, in such magnetic layers of relatively thick single-layer structure, there is generally a problem in the form of loss due to thickness resulting in decreased output.

In order to improve upon the drop in reproduction output as the result of loss due to thickness in the magnetic layer, the thinning of the magnetic layer is known. For example, U.S. Pat. No. 5,447,782 (Japanese Non-Examined Patent Publication No. Hei 5-182178) discloses a magnetic recording medium in which a lower nonmagnetic layer comprising an inorganic powder dispersed in resin is provided on a support and an upper magnetic layer not more than 1.0 μm in thickness comprising a ferromagnetic powder dispersed in binder is provided over said nonmagnetic layer while said nonmagnetic layer is wet.

Based on these inventions, magnetic tapes comprising an upper thin magnetic layer and a lower nonmagnetic layer are employed in the high recording density high capacity computer backup systems known as DLT-IV, DDS-3, and DDS-4.

However, the demand for the development of higher capacity and higher recording density is incessant, and there is a need for improved characteristics.

The improvement of recording heads is progressing as one way of achieving high recording density. In the magnetic heads operating on the principle of magnetic induction (induction-type magnetic heads) that have been conventionally employed, many windings must be provided in the coils of the reproduction head to achieve substantial reproduction output. However, inductance increases and resistance at high frequency increases, resulting in the problem of a drop in reproduction output. Thus, high-density recording and reproduction have reached a limit.

By contrast, reproduction heads operating on the principle of magnetic resistance (MR) have been proposed and have begun to be employed with hard disks and the like. Magnetic resistance magnetic heads (MR heads) achieve several times the reproduction output of induction magnetic heads without employing an inductance coil. Thus, equipment noise such as impedance noise is substantially reduced and an improvement in high-density recording and reproduction characteristics can be anticipated.

With this improvement in magnetic heads comes the necessity of increasing optimization of magnetic recording media. To develop still higher densities requires an increase in the magnetic flux density of the magnetic recording medium itself. However, when this is done, output increases in reproduction with MR heads, but there is an even greater increase in noise. There is effectively a problem in that high C/N ratios cannot be achieved. Further, the linearity between magnetic field strength and resistance is easily thrown off in MR heads. Even at high frequencies, there is a problem in that the C/N ratio drops. In the face of this problem, it is known that a high C/N ratio can be achieved by adequately thinning the magnetic layer by using microgranular metal ferromagnetic powders. However, there are still the problems of deterioration in durability (stylus characteristics) and running properties (friction coefficient); further improvement is known to be necessary.

### SUMMARY OF THE INVENTION

Accordingly, the object of the present invention is to continue the reduction in grain size of the magnetic material and provide a magnetic recording medium with improved running properties and durability in a magnetic recording medium with a thin magnetic layer.

That is, the present invention has for its object to provide a magnetic recording medium for high-density recording with good electromagnetic characteristics and good running durability.

The present invention relates to a magnetic recording medium which comprises a lower layer comprising a nonmagnetic powder and a binder and a magnetic layer comprising a ferromagnetic powder and a binder provided in this order on a nonmagnetic support,

wherein said ferromagnetic powder is a metal ferromagnetic powder with a mean major axis length equal to or less than 0.1 μm, the average thickness of said magnetic layer ranges from 0.01 to 0.1 μm, and the surface lubricant index is 1.1-2.4.

The following modes of the above-described magnetic recording medium are preferred.

(1) A mode in which the acicular ratio of the ferromagnetic powder is 5 or more.

The use of a metal ferromagnetic powder with an acicular ratio of 5 or more as the ferromagnetic powder affords the advantages of improving the orientation properties of the magnetic material, increasing output, and yielding a high C/N ratio through a reduction in noise.

(2) A mode in which the coercivity Hc of the magnetic layer is 159,200-238,800 A/m (2,000-3,000 Oe)

The use of a magnetic layer with a coercivity Hc of not less than 159,200 A/m (2,000 Oe) affords the advantages of increasing output and yielding a high C/N ratio through a reduction in noise, and holding to 238,800 A/m (3,000 Oe) or less affords the advantage of adequate writing of the signal by a recording head such as an MIG head.

(3) A mode of a tape for digital signal recording heads in which the magnetic recording medium is mounted on an MR reproduction head.

### DETAILED DESCRIPTION OF THE INVENTION

In the magnetic recording medium of the present invention, the ferromagnetic powder contained in the magnetic layer is a metal magnetic powder with a mean major axis length of not more than 0.1 μm. The mean major axis length is preferably 0.04-0.09 μm. When the mean major axis length of the metal magnetic power exceeds 0.1 m, noise increases and the C/N ratio drops. Further, using a metal magnetic powder with a mean major axis length of 0.04 μm or greater facilitates obtaining good thermal stability and stable magnetic characteristics.

The mean major axis length of the metal magnetic powder can be determined by projecting a photograph taken by transmission electron microscope of the magnetic material that is the starting material for the magnetic layer and using a known method of statistical calculation to analyze the image. It can also be obtained by sampling magnetic material from the magnetic layer of a magnetic tape and using the same method.

In the magnetic recording medium of the present invention, the average thickness of the magnetic layer ranges from 0.01-0.1 μm. When the average thickness of the magnetic layer is less than 0.01, output drops and an adequate C/N ratio cannot be achieved. Further, when 0.1 μm is exceeded, noise increases and the C/N ratio deteriorates. Accordingly, the average thickness of the magnetic layer preferably ranges from 0.03-0.09 μm, more preferably 0.04-0.08 μm.

The average thickness of the magnetic layer of the present invention is determined in the following manner. An ultrathin section (about 80 nm in thickness) is prepared in the direction of thickness of the magnetic recording medium by the ultrathin sectioning method, a known method of material preparation in transmission electron microscopy, and a photograph of the ultrathin section (50,000 times magnification) taken by transmission electron microscope is projected. The upper layer surface and upper and lower layer interface in the photograph are traced on the film base, 500 parallel straight lines are drawn in the direction of thickness at a spacing of 0.025 μm between the upper layer surface and the upper and lower layer interface, and the average magnetic layer thickness is determined as the average of that length.

As set forth above, in the magnetic recording medium of the present invention, the use of ferromagnetic micrograins and the development of a thin magnetic layer make it possible to achieve a high C/N ratio. Controlling the surface lubricant index to within a range of 1.1-2.4 yields a magnetic recording medium with a low friction coefficient and good running stability. When the surface lubricant index is less than 1.1, stylus characteristics deteriorate, and when the surface lubricant index exceeds 2.4, the friction coefficient rises and running stability deteriorates.

Since the surface lubricant index indicates the amount of lubricant present on the magnetic layer surface, it is controlled by optimizing the composition and quantity of lubricant. Desirable types of lubricants are fatty acids, fatty esters, and the like. The quantity of lubricant present on the surface can be controlled through the compatibility of the binder in which the lubricant and magnetic material are dispersed. When compatibility is high, the lubricant seeps into the magnetic layer, reducing the amount on the surface. When compatibility is low, the quantity on the surface increases. Accordingly, the surface lubricant index can be controlled from the perspective of compatibility by optimizing the type of lubricant, the type of binder, the mixing ratio of the binder resin composition (the ratio of vinyl chloride urethane resin to hardener), and the P/B ratio (the ratio of inorganic powder such as magnetic material to binder resin). When the lubricant tends to be adsorbed onto the magnetic material, the component that has been adsorbed by the magnetic material is present in the magnetic layer, thereby reducing the amount of lubricant material on the surface; this effect can be used to control the amount of surface lubricant even better than by optimizing the type of lubricant and type of magnetic material (surface area, pH, amount of Al and Si contained in the oxide film, and the like).

The surface lubricant index can also be controlled by means of the drying conditions following coating. Generally, speeding up drying of the coating increases the travel speed in the coating of organic solvent that is evaporating, and lubricant that is dissolved therein travels to the coating surface with the solvent, thereby increasing the amount of lubricant on the surface. When the drying temperature is increased to accelerate drying and a readily vaporizing lubricant is employed, the lubricant evaporates. This effect can be used to reduce the amount of surface lubricant. Control is also possible by means of calendering conditions such as the temperature, pressure, hardness of the calender roll; the higher any of these are, the greater the quantity of lubricant on the surface tends to be.

The surface lubricant index of the magnetic recording medium surface is an index indicating the quantity of lubricant on the medium surface and can be measured by the following method. Auger electron spectroscopy is a method of measuring material present on the surface. Auger electron spectroscopy permits the analysis of elements to a depth of several tens of Angstroms from the surface, making it possible to determine the elements that are present on the extreme outer surface and their stoichiometric relation.

In the case of a magnetic recording medium, the quantity of the element carbon that is measured by Auger electron spectroscopy corresponds to the quantity of lubricant and binder resin present on the medium surface. The quantity of elemental iron that is simultaneously measured by Auger electron spectroscopy corresponds to the quantity of magnetic material present on the medium surface. The ratio of the two C/Fe(a) can be determined.

The quantity of elemental carbon that is measured by removing the lubricant from the magnetic recording medium corresponds to the quantity of binder resin on the medium surface. The ratio at that time to the quantity of elemental iron C/Fe(b) can be calculated. The surface lubricant index of the present invention is denoted by {C/Fe(a)}/{C/Fe(b)}.

Lubricant can be removed from the medium by immersing the medium in n-hexane to extract and remove lubricant that has not adsorbed onto the magnetic material, after which lubricant that has adsorbed to the magnetic material can be reacted with a silylating agent, converted into a derivative, extracted, and removed.

[The Magnetic Layer]

The metal ferromagnetic powders employed in the upper magnetic layer of the present invention are preferably ferromagnetic alloy powders chiefly comprising α-Fe. In addition to prescribed atoms, the following atoms can be contained in the ferromagnetic alloy powder: Al, Si, S, Sc, Ca, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, and the like. The incorporation of at least one of the following in addition to α-Fe is particularly desirable: Al, Si, Ca, Y, Ba, La, Nd, Co, Ni, and B. The incorporation of at least one from among C, Y, and Al is still more desirable. The content of Co relative to Fe is preferably 0-40 atomic percent, more preferably 15-35 atomic percent, and still more preferably 20-35 atomic percent. The content of Y is preferably 1.5-15 atomic percent and more preferably 3-12 atomic percent. The content of Al is preferably 1.5-15 atomic percent and more preferably 3-12 atomic percent. The magnetic powder may be pretreated prior to dispersion with dispersing agents, lubricants, surfactants, antistatic agents, and the like, described further below.

The magnetic alloy powder may contain a small quantity of a hydroxide or an oxide. Ferromagnetic alloy powders obtained by known manufacturing methods may be employed. The following are examples: methods of reduction with compound organic acid salts (chiefly oxalates) and reducing gases such as hydrogen; methods of reducing iron oxide with a reducing gas such as hydrogen to obtain Fe or Fe—Co grains or the like; methods of thermal decomposition of metal carbonyl compounds; methods of reduction by addition of a reducing agent such as sodium borohydride, hypophosphite, or hydrazine to an aqueous solution of ferromagnetic metal; and methods of obtaining powder by distilling metals in a low-pressure non-reactive gas. The ferromagnetic alloy powders obtained in this manner may be subjected to any of the known gradual oxidation treatments, such as immersion in an organic solvent followed by drying; the method of immersion in an organic solvent followed by formation of an oxide film on the surface by feeding in an oxygen-containing gas, then drying; and the method of forming an oxide film on the surface by adjusting the partial pressure of oxygen gas and a non-reactive gas without using an organic solvent.

The specific surface area as measured by the BET method of the ferromagnetic powder of the magnetic layer of the present invention is 40-80 m²/g, preferably 45-70 m /g. At 40 m²/g and above, noise drops, and at 80 m²/g and below, surface properties become easier to attain, both of which are desirable. The size of the crystals of the ferromagnetic powder of the magnetic layer of the present invention is 80-180 Angstroms preferably 100-180 Angstroms, and still more preferably, 110-175 Angstroms. The mean major axis length of the ferromagnetic powder is 0.1 μm or less, preferably 0.05-0.09 μm. The acicular ratio of the ferromagnetic powder is preferably 5-15, more preferably 6-12. The acicular ratio is expressed as the ratio of the mean major axis length as measured by transmission electron microscopy and the crystal size as obtained by X-ray analysis. The a s of the magnetic metal powder is 100-180 Am²/kg (100-180 emu/g), preferably 110-170 Am²/kg (110-170 emu/g), and more preferably 125-160 Am²/kg (125-160 emu/g). The coercive force of the metal powder is preferably 119,400-318,400 A/m (1,500-4,000 Oe), preferably 143,280-278,600 A/m (1,800-3,500 Oe), and still more preferably 159,200-238,800 A/m (2,000-3,000 Oe).

The moisture content of the ferromagnetic metal powder is preferably 0.01-2 percent. The moisture content of the ferromagnetic powder is desirably optimized based on the type of binder. The pH of the ferromagnetic powder is desirably optimized based on the combination with the binder. The pH range is 4-12, preferably 6-10. The ferromagnetic powder can be surface treated as needed with Al, Si, P or an oxide thereof. The quantity thereof is 0.1-10 percent of the ferromagnetic powder. When a surface treatment is applied, the adsorption of lubricants such as fatty acids is preferably not more than 100 mg/m². There are cases where soluble Na, Ca, Fe, Ni, Sr, and other inorganic ions are incorporated into the ferromagnetic powder. It is essentially desirable that these not be present, but they seldom affect characteristics at less than 200 ppm. Further, the ferromagnetic powder employed in the present invention desirably has few pores, with the quantity thereof preferably being 20 volume percent or less, more preferably, 5 volume percent or less. The shape may be acicular, rice-grain shaped, or spindle-shaped so long as the above-stated characteristics are satisfied for the size of the grains. A low switching field distribution (SFD) of the ferromagnetic powder itself is desirable, with 0.6 or less being preferred. It is necessary to reduce the distribution of the Hc of the ferromagnetic powder. When the SFD is 0.6 or less, electromagnetic characteristics are good, output is high, magnetization reversal is sharp, and there are few peak shifts; this level is suited to high density digital magnetic recording. Methods of reducing Hc distribution include improving the grain size distribution of the gertite in the ferromagnetic metal powder and preventing sintering.

In the present invention, an abrasive may be incorporated into the magnetic layer. Known materials with a Mohs hardness of 6 or greater, chiefly α-alumina having an α-conversion rate or not less than 90 percent, β-alumina, silicon carbide, chromium oxide, cerium oxide, α-iron oxide, corundum, artificial diamond, silicon nitride, silicon carbide, titanium carbide, titanium oxide, silicon dioxide and boron nitride, may be used singly or in combination. Further, a composite comprising two or more of these abrasives (an abrasive obtained by surface-treating one abrasive with another) may also be used. Although these abrasives may contain compounds and elements other than the main component or element in some cases, the same effect is obtainable if the content of the main component comprises not less than 90 weight percent. A tap density of 0.3-2 g/mL, a moisture content of 0.1-5 weight percent, a pH of 2-11, and a specific surface area of 1-30 m²/g are desirable. The abrasive employed in the present invention may be acicular, spherical, or cubic in shape, but shapes that are partially angular have good abrasion properties and are thus preferred. Specific examples of abrasives employed in the present invention are: AKP-20, AKP-30, AKP-50, HIT-50, HIT-55, HIT-60A, HIT-70, and HIT-100 manufactured by Sumitomo Chemical Co. Ltd.; G5, G7 and S-1 manufactured by Nippon Chemical Industrial Co. Ltd.; and TF-100 and TF-140 manufactured by Toda Kogyo K.K. It is of course possible in the present invention to separately determine the type, quantity, and combination of abrasives employed in the magnetic layers (upper and lower layers) and nonmagnetic layer of the present invention based on the objective. These abrasives may be added to the magnetic coating after being dispersion treated in advance with binder.

Carbon black may be incorporated into the magnetic layer in the present invention. Examples of types of carbon black that are suitable for use are: furnace black for rubber, thermal for rubber, black for coloring, and acetylene black. A specific surface area of 5 to 500 m²/g, a DBP oil absorption rate of 10 to 400 mL/100 g, a grain diameter of 5 nm to 300 nm, a pH of 2 to 10, a moisture content of 0.1 to 10 weight percent, and a tap density of 0.1 to 1 g/mL are desirable. Specific examples of types of carbon black employed in the present invention are: BLACK PEARLS 2000, 1300, 1000, 900, 800, 700 and VULCAN XC-72 manufactured by Cabot Corporation; #80, #60, #55, #50 and #35 manufactured by Asahi Carbon Co. Ltd.; #2400B, #2300, #900, #1000, #30, #40 and #10B manufactured by Mitsubishi Chemical Industries Corp.; and CONDUCTEX SC, RAVEN 150, 50, 40 and 15 manufactured by Columbia Carbon Co. Ltd. The carbon black employed may be surface-treated with a dispersant or grafted with resin, or have a partially graphite-treated surface. The carbon black may be dispersed in advance into the binder prior to addition to the magnetic coating solution. These carbon blacks may be used singly or in combination.

When employing carbon black, the quantity employed is preferably 0.1-30 weight percent.

Carbon black works to prevent static in the magnetic layer, reduce the friction coefficient, impart light-blocking properties, enhance film strength, and the like; the properties vary with the type of carbon black. Accordingly, the type, quantity, and combination of carbon blacks employed in the present invention may be determined separately for the magnetic layer and the lower layer based on the objective and the various characteristics stated above, such as grain size, oil absorption, electrical conductivity, and pH. For example, the Carbon Black Handbook compiled by the Carbon Black Association may be consulted for types of carbon black suitable for use in the magnetic layer of the present invention.

Conventionally known thermoplastic resins, thermosetting resins, reactive resins and mixtures thereof may be employed as binders in the present invention. Preferred thermoplastic resins have a glass transition temperature of −100 to 150° C., a number average molecular weight of 1,000-200,000, preferably 10,000-100,000, and a polymerization degree of about 50-1,000.

Examples of such thermoplastic resins are polymers and copolymers comprising structural units in the form of vinyl chloride, vinyl acetate, vinyl alcohol, maleic acid, acrylic acid, acrylic acid esters, vinylidene chloride, acrylonitrile, methacrylic acid, methacrylic acid esters, styrene, butadiene, ethylene, vinyl butyral, vinyl acetal, and vinyl ether; polyurethane resins; and various rubber resins. Examples of thermosetting resins and reactive resins are phenol resins, epoxy resins, polyurethane cured resins, urea resins, melanine resins, alkyd resins, acrylic reactive resins, formaldehyde resins, silicone resins, epoxy polyamide resins, mixtures of polyester resins and isocyanate prepolymers, mixtures of polyester polyols and polyisocyanates, and mixtures of polyurethane and polyisocyanates. These resins are described in detail in the Handbook of Plastics published by Asakura Shoten. It is also possible to employ known electron beam-cured resins into the individual layers. These examples and methods of manufacturing the same are described in Japanese Un-examined Patent Publication No. Sho 62-256219. The above-listed resins may be used singly or in combination. Preferred resins are combinations of polyurethane resin and at least one member selected from the group consisting of vinyl chloride resin, vinyl chloride-vinyl acetate copolymers, vinyl chloride-vinyl acetate-vinyl alcohol copolymers, and vinyl chloride-vinyl acetate-maleic anhydride copolymers, as well as combinations of the same with polyisocyanate.

Known structures of polyurethane resin can be employed, such as polyester polyurethane, polyether polyurethane, polyether polyester polyurethane, polycarbonate polyurethane, polyester polycarbonate polyurethane, and polycaprolactone polyurethane. To obtain better dispersability and durability in all of the binders set forth above, it is desirable to introduce by copolymerization or addition reaction one or more polar groups selected from among —COOM, —SO₃M, —OSO₃M, —P═O(OM)₂, —O—P—O(OM)₂, (where M denotes a hydrogen atom or an alkali metal base), —OH, —NR₂, —N⁺R₃, (where R denotes a hydrocarbon group), an epoxy group, —SH, and —CN. The quantity of the polar group is from 10⁻¹ to 10⁻⁸ mol/g, preferably from 10⁻² to 10⁻⁶ mol/g.

Specific examples of the binders employed in the present invention are VAGH, VYHH, VMCH, VAGF, VAGD, VROH, VYES, VYNC, VMCC, XYHL, XYSG, PKHH, PKHJ, PKHC, and PKFE from Union Carbide Co.; MPR-TA, MPR-TA5, MPR-TAL, MPR-TSN, MPR-TMF, MPR-TS, MPR-TM, and MPR-TAO from Nisshin Chemical Industries Co.; 1000W, DX80, DX81, DX82, DX83, and 100FD from Denki Kagaku Co.; MR-104, MR-105, MR110, MR100, MR555, and 400X-110A from Nippon Zeon Co.; Nipporan N2301, N2302, and N2304 from Nippon Polyurethane Co.; Pandex T-5105, T-R3080, T-5201, Parnock D-400, D-210-80, Krisbon 6109, and 7209 from Dainippon Ink Co.; Bylon UR8200, UR8300, UR-8700, RV530, and RV280 from Toyobo Co.; Dipheramin 4020, 5020, 5100, 5300, 9020, 9022, and 7020 from Dainichi Seika Co.; MX5004 from Mitsubishi Chemical Co.; Sanprene SP-150 from Sanyo Chemical Co.; Saran F310 and F210 from Asahi Chemical Co.

The binder employed in the nonmagnetic layer and magnetic layer of the present invention is employed in a range of 5-50 percent, preferably 10-30 percent, relative to the nonmagnetic powder or magnetic powder. Vinyl chloride resin, polyurethane resin, and polyisocyanate are preferably combined within the ranges of: 5-30 percent for vinyl chloride resin, when employed; 2-20 percent for polyurethane resin, when employed; and 2-20 percent for polyisocyanate. However, when a small amount of dechlorination causes head corrosion, for example, it is also possible to employ polyurethane alone, or employ polyurethane and isocyanate alone. In the present invention, when polyurethane is employed, a glass transition temperature of −50 to 150° C., preferably 0-100° C., an elongation at break of 100-2,000 percent, a stress at break of 0.05-10 Kg/mm², and a yield point of 0.05-10 Kg/mm² are desirable.

The magnetic recording medium of the present invention comprises at least the two layers of a lower layer (nonmagnetic layer) and a magnetic layer. Accordingly, the quantity of binder; the quantity of vinyl chloride resin, polyurethane resin, polyisocyanate, or some other resin in the binder; the molecular weight of each of the resins forming the magnetic layer; the quantity of polar groups; and the physical characteristics of the above-described reins can naturally be different in the nonmagnetic layer and the magnetic layer as required. These must be optimized in each layer. Known techniques may be applied for a multilayered magnetic layer. For example, when the quantity of binder is different in each layer, increasing the quantity of binder in the magnetic layer effectively decreases scratching on the surface of the magnetic layer. To achieve good head touch, the quantity of binder in the nonmagnetic layer can be increased to impart flexibility.

Examples of polyisocyanates employed in the present invention are tolylene diisocyanate, 4,4′-diphenylmethane diisocyanate, hexamethylene diisocyanate, xylylene diisocyanate, napthylene-1,5-diisocyanate, o-toluidine diisocyanate, isophorone diisocyanate, triphenylmethane triisocyanate, and other isocyanates; products of these isocyanates and polyalcohols; polyisocyanates produced by condensation of isocyanates; and the like. These isocyanates are commercially available under the following trade names, for example: Coronate L, Coronate HL, Coronate 2030, Coronate 2031, Millionate MR and Millionate MTL manufactured by Nippon Polyurethane Co. Ltd.; Takenate D-102, Takenate D-110N, Takenate D-200 and Takenate D-202 manufactured by Takeda Chemical Industries Co. Ltd.; and Desmodule L, Desmodule IL, Desmodule N and Desmodule HL manufactured by Sumitomo Bayer Co. Ltd. They can be used singly or in combinations of two or more in all layers by exploiting differences in curing reactivity.

Substances having lubricating effects, antistatic effects, dispersive effects, plasticizing effects, or the like may be employed as additives in the present invention. Examples are: molybdenum disulfide; tungsten graphite disulfide; boron nitride; graphite fluoride; silicone oils; silicones having a polar group; fatty acid-modified silicones; fluorine-containing silicones; fluorine-containing alcohols; fluorine-containing esters; polyolefins; polyglycols; alkylphosphoric esters and their alkali metal salts; alkylsulfuric esters and their alkali metal salts; polyphenyl ethers; fluorine-containing alkylsulfuric esters and their alkali metal salts; monobasic fatty acids having 10 to 24 carbon atoms (which may contain an unsaturated bond or may be branched) and metal (e.g., Li, Na, K, Cu) salts thereof; monohydric, dihydric, trihydric, tetrahydric, pentahydric and hexahydric alcohols having 12 to 22 carbon atoms (which may contain an unsaturated bond or be branched); alkoxy alcohols having 12 to 22 carbon atoms; monofatty esters, difatty esters, or trifatty esters comprising a monobasic fatty acid having 10 to 24 carbon atoms (which may contain an unsaturated bond or be branched) and any one from among a monohydric, dihydric, trihydric, tetrahydric, pentahydric or hexahydric alcohol having 2 to 12 carbon atoms (which may contain an unsaturated bond or be branched); fatty esters of monoalkyl ethers of alkylene oxide polymers; fatty acid amides having 8 to 22 carbon atoms; aliphatic amines having 8 to 22 carbon atoms; and the like.

Specific examples of compounds suitable for use are: lauric acid, myristic acid, palmitic acid, stearic acid, behenic acid, butyl stearate, oleic acid, linolic acid, linolenic acid, elaidic acid, octyl stearate, amyl stearate, isooctyl stearate, octyl myristate, butoxyethyl stearate, anhydrosorbitan monostearate, anhydrosorbitan distearate, anhydrosorbitan tristearate, oleyl alcohol and lauryl alcohol. It is also possible to employ nonionic surfactants such as alkylene oxide-based surfactants, glycerin-based surfactants, glycidol-based surfactants and alkylphenolethylene oxide adducts; cationic surfactants such as cyclic amines, ester amides, quaternary ammonium salts, hydantoin derivatives, heterocycles, phosphoniums, and sulfoniums; anionic surfactants comprising acid groups, such as carboxylic acid, sulfonic acid, phosphoric acid, sulfuric ester groups, and phosphoric ester groups; and ampholytic surfactants such as amino acids, amino sulfonic acids, sulfuric or phosphoric esters of amino alcohols, and alkyl betaines.

Details of these surfactants are described in A Guide to Surfactants (published by Sangyo Tosho K.K.). These lubricants, antistatic agents and the like need not be 100 percent pure and may contain impurities, such as isomers, unreacted material, by-products, decomposition products and oxides in addition to the main components. These impurities preferably comprise not more than 30 weight percent, and more preferably not more than 10 percent, by weight.

The lubricants and surfactants employed in the present invention may be employed differently in the lower layer and magnetic upper layer as needed based on type and quantity. For example, it is conceivable to control bleeding onto the surface through the use in the lower layer and the magnetic upper layer of fatty acids having different melting points, to control bleeding onto the surface through the use of esters having different boiling points and polarities, to improve coating stability by adjusting the amount of surfactant, and to enhance the lubricating effect by increasing the amount of lubricant added to the nonmagnetic layer; this is not limited to the examples given here. All or some of the additives used in the present invention may be added at any stage in the process of manufacturing the magnetic coating solution. For example, they may be mixed with the ferromagnetic powder before a kneading step; added during a step of kneading the ferromagnetic powder, the binder, and the solvent; added during a dispersing step; added after dispersing; or added immediately before coating. Part or all of the additives may be applied by simultaneous or sequential coating after the magnetic layer has been applied to achieve a specific purpose. Depending on the objective, the lubricant may be coated on the surface of the magnetic layer after calendering or making slits.

Examples of the trade names of lubricants suitable for use in the present invention are: NAA-102, NAA-415, NAA-312, NAA-160, NAA-180, NAA-174, NAA-175, NAA-222, NAA-34, NAA-35, NAA-171, NAA-122, NAA-142, NAA-160, NAA-173K, hydrogenated castor oil fatty acid, NAA-42, NAA-44, Cation SA, Cation MA, Cation AB, Cation BB, Nymeen L-201, Nymeen L-202, Nymeen S-202, Nonion E-208, Nonion P-208, Nonion S-207, Nonion K-204, Nonion NS-202, Nonion NS-210, Nonion HS-206, Nonion L-2, Nonion S-2, Nonion S-4, Nonion 0-2, Nonion LP-20R, Nonion PP-40R, Nonion SP-60R, Nonion OP-80R, Nonion OP-85R, Nonion LT-221, Nonion ST-221, Nonion OT-221, Monogly MB, Nonion DS-60, Anon BF, Anon LG, butyl stearate, butyl laurate, and erucic acid manufactured by Nippon Oil and Fat Corp.; oleic acid manufactured Kanto Chemical Co. Ltd; FAL-205 and FAL-123 manufactured by Takemoto Yushi K.K.; NJLUB LO, NJLUB IPM, and Sansosyzer E4030 manufactured by Shin Nippon Chemical Co. Ltd.; TA-3, KF-96, KF-96L, KF96H, KF410, KF420, KF965, KF54, KF50, KF56, KF907, KF851, X-22-819, X-22-822, KF905, KF700, KF393, KF-857, KF-860, KF-865, X-22-980, KF-101, KF-102, KF-103, X-22-3710, X-22-3715, KF-910 and KF-3935 manufactured by Shinetsu Chemical Co. Ltd.; Armide P, Armide C and Armoslip CP manufactured by Lion Arma K.K.; Duomine TDO manufactured by Lion Yushi K.K.; BA-41G manufactured by Nisshin Oil Mills, Co. Ltd.; Profan 2012E, Newpole PE61, lonet MS-400, Ionet MO-200, Ionet DL-200, lonet DS-300, Ionet DS-1000 and lonet DO-200 manufactured by Sanyo Chemical Industries Co. Ltd.

The abrasives, binder quantities, additives, and dispersing agents described above may be applied to the lower layer as well as the upper magnetic layer. Known techniques relating to these additives may be applied.

[Lower Layer (Nonmagnetic Layer)]

The detailed contents of the lower layer (nonmagnetic layer) will be described next.

The nonmagnetic powder employed in the lower layer of the present invention is, for example, an inorganic powder. The inorganic powder may be selected from among inorganic compounds such as metal oxides, metal carbonates, metal sulfates, metal nitrates, metal carbides, and metal sulfides. Examples of inorganic compounds are α-alumina having an α-conversion rate or not less than 90 percent, β-alumina, γ-alumina, θ-alumina, silicon carbide, chromium oxide, cerium oxide, α-iron oxide, bematite, gertite, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum sulfate. These may be employed singly or in combination. Titanium dioxide, zinc oxide, iron oxide, and barium sulfate are particularly preferred because of their small grain size distribution and the numerous methods available to impart functions. Even more preferred are titanium dioxide and α-iron oxide. The grain size of these nonmagnetic powders is preferably 0.005-0.5 μm, but when necessary, nonmagnetic powders of other grain sizes may be combined and a broad grain size distribution may be employed within a single nonmagnetic powder to achieve the same effect. What is preferred most is a grain size in the nonmagnetic powder of 0.01-0.2 μm. Particularly when the nonmagnetic powder is a granular metal oxide, a mean grain diameter of not greater than 0.08 μm is preferred, and when an acicular metal oxide, a major axis length of not more than 0.2 μm, preferably not more than 0.15 μm, and still more preferably not more than 0.1 μm is suitable. The acicular ratio of the nonmagnetic powder is 2-20, preferably 3-10. The tap density is 0.05-2 g/mL, preferably 0.2-1.5 g/mL. The moisture content of the nonmagnetic powder is 0.1-5 weight percent, preferably 0.2-3 weight percent, and still more preferably 0.3-1.5 weight percent. The pH of the nonmagnetic powder is 2-11, with a pH range from 5.5-10 being particularly desirable. Since adsorption of function groups is good under these conditions, dispersion is good and the coating has high mechanical strength.

The specific surface area of the nonmagnetic powder is 1-100 m²/g, preferably 5-80 m²/g, and still more preferably, 10-70 m²/g. The grain size of the nonmagnetic powder is 0.004-1 μm, preferably 0.04-0.1 μm. Dibutyl phthalate (DBP) oil absorption is 5-100 mL/100 g, preferably 10-80 mL/100 g, and still more preferably 20-60 mL/100 g. The specific gravity is 1-12, preferably 3-6. The shape may be acicular, spherical, polyhedral, or tabular. A powder with a Mohs hardness of not less than 4 and not greater than 10 is preferred. The SA (stearic acid) absorption level of the nonmagnetic powder is 1-20 pmol/m², preferably 2-15 pmol/m², and more preferably 3-8 pmol/m². The pH is preferably between 3-6. The surfaces of these nonmagnetic powders are preferably treated so that Al₂O₃, SiO₂, TiO₂, ZrO₂, SnO₂, Sb₂O₃, ZnO, and Y₂O₃ are present. Al₂O₃, SiO₂, TiO₂, and ZrO₂ have particularly desirable dispersion properties. Al₂O₃, SiO₂, and ZrO₂ are even more preferred. These may be employed singly or in combination. Depending on the objective, a coprecipitated surface-treated layer may be employed, the outer layer may be first treated with alumina and then with silica, or the reverse method may be adopted. Depending on the objective, the surface treated layer may be a porous layer, but homogeneity and density are generally desirable.

Specific examples of nonmagnetic powders suitable for use in the lower layer of the present invention are: Nanotite from Showa Denko; HIT-100 and ZA-G1 from Sumitomo Chemicals; α-hematite DPN-250, DPN-250BX, DPN-245, DPN-270BX, DPN-500BX, DBN-SA1, and DBN-SA3 from Toda Kogyo; titanium oxide TTO-51B, TTO-55A, TTO-55B, TTO-55C, TTO-55S, TTO-55D, SN-100, a -hematite E270, E271, E300, and E303 from Ishihara Sangyo; titanium oxide STT-4D, STT-30D, STT-30, STT-65C, and α-hematite α-40 from Titan Kogyo; MT-100S, MT-100T, MT-150W, MT-500B, MT-600B, MT-100F, and MT-500HD from Teika; FINEX-25, BF-1, BF-10, BF-20, and ST-M from Sakai Chemicals; DEFIC-Y and DEFIC-R from Dowa Kogyo; AS2BM and TiO2P25 from Nippon Aerogil; 100A and 500A from Ube Kosan; and sintered products of the same. Titanium dioxide and iron α-oxide are the nonmagnetic powders of preference.

Mixing carbon black into the lower layer achieves the known effects of lowering surface resistivity Rs and reducing light transmittance, as well as yielding the desired micro Vickers hardness. Examples of types of carbon black that are suitable for use are furnace black for rubber, thermal for rubber, black for coloring, and acetylene black.

The specific surface area of the carbon black in the lower layer is 100-500 m²/g, preferably 150-400 m²/g. DBP oil absorption is 20-400 mL/100 g, preferably 30-400 mL/100 g. The grain diameter of the carbon black is 5-80 nm, preferably 10-50 nm, and more preferably 10-40 nm. The preferred pH of the carbon black is 2-10, moisture content is 0.1-10 percent, and tap density is 0.1-1 g/mL. Specific examples of types of carbon black suitable for use in the present invention are: BLACK PEARLS 2000, 1300, 1000, 900, 800, 880, and 700; VULCAN XC-72; #3050B, #3150B, #3250B, #3750B, #3950B, #950, #650B, #970B, #850B, MA-600, MA-230, #4000, and #4010 from Mitsubishi Kasei Kogyo; CONDUCTEX SC, RAVEN 8800, 8000, 7000, 5750, 5250, 3500, 2100, 2000, 1800, 1500, 1255, and 1250 from Columbia Carbon; and Ketchen Black EC from Axo. The carbon black employed can be surface treated with a dispersing agent or the like, grafted with a resin, or a portion of the surface may be graphite-treated. The carbon black may be predispersed with a binder prior to being added to the coating material. These types of carbon black are employed in a range that does not exceed 50 weight percent of the inorganic powder and does not exceed 40 percent of the total weight of the nonmagnetic layer. These types of carbon black may be employed singly or in combination. The Carbon Black Handbook compiled by the Carbon Black Association may be consulted for types of carbon black suitable for use in the present invention.

Based on the objective, an organic powder may be added to the lower layer. Examples are acrylic styrene resin powders, benzoguananine resin powders, melamine resin powders, and phthalocyanine pigments. Polyolefin resin powders, polyester resin powders, polyamide resin powders, polyimide resin powders, and polyethylene fluoride may also be employed. The manufacturing methods described in Japanese Un-examined Patent Publication Nos. Sho 62-18564 and Sho 60-255827 may be employed.

The binder resins, lubricants, dispersing agents, additives, solvents, dispersion methods, and the like described below for use in the magnetic layer may be applied to the lower layer. In particular, known techniques employed for the magnetic layer can be applied to the type and quantity of binder resin and the type and quantity of additives and dispersing agents that are added.

[Layer Structure]

In the thickness structure of the magnetic recording medium of the present invention, the nonmagnetic support is 2-100 μm, preferably 2-80 μm. Nonmagnetic supports with a thickness ranging from 3.0-10 μm (preferably 3.0-8.0 μm, more preferably 3.0-5.5 μm) are employed in computer tapes.

An undercoating layer may be provided to improve adhesion between the nonmagnetic flexible support and the nonmagnetic layer or magnetic layer. The thickness of the undercoating layer is 0.01-0.5 μm, preferably 0.02-0.5 μm. Even though the present invention is normally a two-sided magnetic layer disk medium on which a nonmagnetic layer and a magnetic layer are provided on both sides of the support, these layers may be provided on just one side. In that case, a backcoat layer may be provided on the reverse side from the nonmagnetic layer and the magnetic layer to correct for curling and prevent static electricity. The thickness thereof is 0.2-1.5 μm, preferably 0.3-0.8 μm. Known undercoating layers and backcoat layers may be employed.

The thickness of the nonmagnetic layer that is the lower layer of the medium of the present invention is 0.2-5.0 μm, preferably 0.3-3.0 μm, and more preferably 1.0-2.5 μm.

[The Backcoat Layer]

Generally, in magnetic tapes for computer data recording, greater repeat running properties are demanded than is the case for videotapes and audiotapes. To maintain such high running durability, the backcoat layer preferably contains carbon black and inorganic powder.

Two types of carbon black having different average grain sizes are preferably combined for use. In that case, a microgranular carbon black with an average grain size of 10-20 nm and a coarse-grained carbon black with an average grain size of 230-300 nm are preferably combined for use. Generally, the addition of microgranular carbon black such as that set forth above makes it possible to set a low surface resistivity and a low light transmittance for the backcoat layer. Magnetic recording devices exploit the light transmittance of the tape, and it is often employed for operation signals. Thus, in such cases, the addition of microgranular carbon black is particularly effective. Further, microgranular carbon black generally has good liquid lubricant holding power, so that when a lubricant is used in combination, it contributes to reducing the friction coefficient. The coarse carbon black with a grain size of 230-300 nm functions as a solid lubricant and forms minute protrusions on the outer surface of the backlayer, reducing the contact surface area and contributing to a reduction in the friction coefficient. However, coarse grain carbon black tends to peel off the backcoat layer due to sliding of the tape in severely traveled systems and has the drawback of contributing to an increased error rate.

Examples of specific products of microgranular carbon black follow:

RAVEN 2000B (18 nm), RAVEN 1500B (17 nm) (from Columbia Carbon Co.); BP800 (17 nm) (from Cabot); PRINTEX 90 (14 nm), PRINTEX 95 (15 nm), PRINTEX 85 (16 nm), and PRINTEX 75 (17 nm) (from Degusa); and #3950 (16 nm) (from Mitsubishi Kasei Kogyo).

Examples of specific products of coarse grain carbon black are Thermal Black (270 nm) (from Karnkalb) and RAVEN MTP (275 nm) (from Columbia Carbon).

When two types of differing average grain size are employed in the backcoat layer, the content ratio (by weight) of microgranular carbon black with an average grain size of 10-20 nm to the 230-300 nm coarse-grained carbon black desirably falls within the range of from 98:2 to 75:25, more preferably from 95:5 to 85:15.

The content of carbon black (the total quantity when two types of carbon black are employed) in the backcoat layer normally falls within the range of 30-80 weight parts, preferably 45-65 weight parts, per 100 weight parts of binder.

Two inorganic powders of different hardnesses are preferably employed in combination.

Specifically, a soft inorganic powder with a Mohs hardness of 3-4.5 and a hard inorganic powder with a Mohs hardness of 5-9 are preferably employed.

Adding a soft inorganic powder with a Mohs hardness of 3-4.5 permits stabilization of the friction coefficient with repeat running. Further, at this hardness range, the slide guide poles are not worn down. The average grain size of the inorganic powder is preferably 30-50 nm.

Examples of soft inorganic powders with Mohs hardnesses of 3-4.5 are: calcium sulfate, calcium carbonate, calcium silicate, barium sulfate, magnesium carbonate, zinc carbonate, and zinc oxide. These may be employed singly or in combinations of two or more. Of these, calcium carbonate is preferred.

The content of soft inorganic powder in the backcoat layer is preferably 10-140 weight parts, more preferably 35-100 weight parts, per 100 weight parts of carbon black.

Adding a hard inorganic powder with a Mohs hardness of 5-9 enhances the strength of the backcoat layer and improves running durability. When this inorganic powder is employed together with the carbon black and the above-described soft inorganic powder, deterioration is reduced even with repeated sliding and a strong backcoat layer is obtained. The addition of this inorganic powder imparts a suitable degree of abrasive strength, reducing adhesion of scrapings to the tape guide poles or the like. In particular, when a soft inorganic powder (calcium carbonate being preferred) is employed in combination, the sliding characteristics of the guide poles, which have rough surfaces, are improved and the friction coefficient of the backcoat layer can be stabilized.

The hard inorganic powder preferably has an average grain size of 80-250 nm (more preferably 100-210 nm).

Examples of hard inorganic powders with Mohs hardnesses of 5-9 are α-iron oxide, α-alumina, and chromium oxide (Cr₂O₃). These powders may be used singly or in combination. Of these, α-iron oxide or α-alumina is preferred. The content of the hard inorganic powder is normally 3-30 weight parts, preferably 3-20 weight parts, per 100 weight parts of carbon black.

When the above-described soft inorganic powder and hard inorganic powder are employed in the backcoat layer, the soft inorganic powder and the hard inorganic powder are preferably selected so that there is a difference in hardness between the soft inorganic powder and the hard inorganic powder of not less than 2 (preferably, not less than 2.5, more preferably, not less than 3).

The backcoat layer desirably comprises the above-described two types of organic powders of prescribed average grain size and differing Mohs hardnesses and the above-described two types of carbon black having different average grain sizes. In particular, calcium carbonate is incorporated into this combination as the soft inorganic powder.

A lubricant can be incorporated into the backcoat layer. The lubricant may be suitably selected from among the lubricants given as examples of lubricants employed in the nonmagnetic layer or magnetic layer above. The lubricant is normally added to the backcoat layer in a range of 1-5 weight parts per 100 weight parts of binder.

[The Nonmagnetic Flexible Support]

Known films may be employed as the flexible nonmagnetic support in the present invention, including polyesters such as polyethylene terephthalate and polyethylene naphthalate, polyolefins, cellulose triacetate, polycarbonates, polyamides, polyimides, polyamidoimides, polysulfones, aramide, and aromatic polyamides. These supports may be subjected beforehand to corona discharge treatment, plasma treatment, adhesion enhancing treatment, heat treatment, dust removal, and the like.

As required to achieve the object of the present invention, the coarseness of the shape of the surface of the nonmagnetic support may be controlled as desired through the size and quantity of filler that is added to the support. Examples of such fillers are oxides and carbonates of Ca, Si, Ti, and the like, as well as organic powders such as acrylics. A maximum height SRmax of the support of not more than 1 μtm, a ten-point average roughness SRz of 0.5 μm or less, a center surface peak height SRp of 0.5 μm or less, a center surface valley depth SRv of 0.5 μm or less, a center surface area ratio SSr of 10 percent or more and 90 percent or less, and an average wavelength Sλa of not less than 5 μm and not more than 300 μm are preferred. The surface protrusion distribution of these supports may be controlled as desired with fillers to achieve desired electromagnetic characteristics and durability. Those having a magnitude of 0.01-1 μm may be controlled to within the range of 0 to 2000 per 0.1 mm².

The F-5 value of the nonmagnetic support employed in the present invention is preferably 5-50 Kg/mm² and the thermal shrinkage rate of the support after 30 minutes at 100° C. is preferably 3 percent or less, more preferably 1.5 percent or less. The thermal shrinkage rate after 30 min at 80° C. is 1 percent or less, preferably 0.5 percent or less. A breaking strength of 5-100 Kg/mm² and a modulus of elasticity of 100-2,000 Kg/mm² are preferred. The coefficient of thermal expansion is from 10⁻⁴ to 10⁻⁸/° C., preferably 10⁻⁵ to 10⁻⁶/° C. The coefficient of moisture expansion is 10⁻⁴/RH% or less, preferably 10⁻⁵/RH% or less. These thermal characteristics, dimensional characteristics, and mechanical strength characteristics are preferably nearly equal, differing by less than 10 percent in any direction within the surface of the support.

[Methods of Manufacturing the Magnetic Recording Medium]

The magnetic recording medium of the present invention may be manufactured by applying and drying a coating solution to form the individual layers. The process for manufacturing the coating solution comprises at least a kneading step, a dispersing step, and a mixing step to be carried out, if necessary, before or after the kneading and dispersing steps. Each of the individual steps may be divided into two or more stages. All of the starting materials employed in the present invention, including the ferromagnetic powder, binders, carbon black, abrasives, antistatic agents, lubricants, solvents, and the like, may be added at the beginning of, or during, any of the steps. Moreover, the individual materials may be divided and added during two or more steps; for example, the polyurethane may be divided up and added in the kneading step, the dispersing step, and the mixing step for viscosity adjustment after dispersion.

The organic solvent employed in the magnetic recording medium of the present invention may be used in any ratio. Examples are ketones such as acetone, methyl ethyl ketone, methyl isobutyl ketone, diisobutyl ketone, cyclohexanone, isophorone, and tetrahydrofuran; alcohols such as methanol, ethanol, propanol, butanol, isobutyl alcohol, isopropyl alcohol, and methylcyclohexanol; esters such as methyl acetate, butyl acetate, isobutyl acetate, isopropyl acetate, ethyl lactate, and glycol acetate; glycol ethers such as glycol dimethyl ether, glycol monoethyl ether, and dioxane; aromatic hydrocarbons such as benzene, toluene, xylene, cresol, and chlorobenzene; chlorinated hydrocarbons such as methylene chloride, ethylene chloride, carbon tetrachloride, chloroform, ethylene chlorohydrin, and dichlorobenzene; N,N-dimethylformamide; and hexane. These organic solvents need not be 100 percent pure and may contain impurities such as isomers, unreacted materials, by-products, decomposition products, oxides and moisture in addition to the main components. The content of these impurities is preferably not more than 30 percent, more preferably not more than 10 percent. Preferably the same type of organic solvent is employed in the present invention in the magnetic layer and in the nonmagnetic layer. However, the amount added may be varied. The stability of coating is increased by using a solvent with a high surface tension (such as cyclohexane or dioxane) in the nonmagnetic layer. Specifically, it is important that the arithmetic mean value of the upper layer solvent composition not be less than the arithmetic mean value of the lower layer solvent composition. To improve dispersion properties, a solvent having a somewhat strong polarity is desirable. It is desirable that solvents having a dielectric constant of 15 or more comprise not less than 50 percent of the solvent composition. Further, the dissolution parameter is desirably from 8 to 11.

To manufacture the magnetic recording medium of the present invention, conventionally known manufacturing techniques may of course be utilized for some of the steps. In the kneading step, using a kneader having a strong kneading force, such as a continuous kneader or a pressure kneader, makes it possible to obtain a magnetic recording medium with a high residual magnetic flux density (Br). When a continuous kneader or pressure kneader is employed, the ferromagnetic powder and all or part of the binder (preferably not less than 30 percent of the entire quantity of binder) are kneaded in the range of 15 to 500 parts of binder per 100 parts of ferromagnetic powder. Details of the kneading process are described in Japanese Un-examined Patent Publication Nos. Hei 1-106338 and Sho 64-79274. When adjusting the lower nonmagnetic layer solution, a dispersing medium having a high specific gravity is desirably utilized, with zirconia beads being suitable.

A method may be employed in which a nonmagnetic layer-forming coating solution comprising nonmagnetic powder and binder and a magnetic layer-forming coating solution comprising ferromagnetic powder and binder are simultaneously or sequentially applied on the nonmagnetic flexible support in such a manner that a magnetic layer is formed on a nonmagnetic layer over the nonmagnetic flexible support, and a smoothing treatment and magnetic field orientation are conducted while the coating layers are still wet.

The following are examples of devices and methods for coating the magnetic recording medium having a multilayered structure.

1. The lower layer is first applied with a coating device commonly employed to apply magnetic coating solutions such as a gravure coating, roll coating, blade coating, or extrusion coating device, and the upper layer is applied while the lower layer is still wet by means of a support pressure extrusion coating device such as is disclosed in Japanese Examined Patent Publication No. Hei 1-46186 and Japanese un-examined Patent Publication Nos. Sho 60-238178 and Hei 2-265672.

2. The upper and lower layers are applied nearly simultaneously by a single coating head having two built-in slits for passing coating solution, such as is disclosed in Japanese Un-examined Patent Publication Nos. Sho 63-88080, Hei 2-17971, and Hei 2-265672.

3. The upper and lower layers are applied nearly simultaneously using an extrusion coating apparatus with a backup roller as disclosed in Japanese Un-examined Patent Publication No. Hei 2-174965.

To avoid compromising the electromagnetic characteristics or the like of the magnetic recording medium by aggregation of ferromagnetic powder, shear is desirably imparted to the coating solution in the coating head by a method such as disclosed in Japanese Un-examined Patent Publication No. Sho 62-95174 or Hei 1-23698. In addition, the viscosity of the coating solution suitably satisfies the numerical range specified in Japanese Un-examined Patent Publication No. Hei 3-8471.

The smoothing process may be conducted by placing a stainless-steel plate on the surface of the coated layers over a web. Additionally, the method employing a solid smoother described in Japanese Examined Patent Publication No. Sho 60-57378, the method of scraping and measuring the coated solution with a rod that is stationary or rotates in the web travel direction and opposite direction, and the method of smoothing the surface by contacting a flexible rod with the surface of the coating solution film can be employed.

In magnetic orientation, a solenoid of not less than 100 mT and a cobalt magnet of not less than 200 mT are desirably employed together in orientation with like poles opposed. Further, when the present invention is being applied as a disk medium, an orientation method achieving random orientation is required.

Heat-resistant plastic rollers of epoxy, polyimide, polyamide, polyimidoamide or the like are employed as calender processing rollers. Processing may also be conducted with metal rollers. The processing temperature is preferably not less than 70° C., more preferably not less than 80° C. Linear pressure is desirably 200 kg/cm, more preferably 300 kg/cm or more. The friction coefficient for SUS420J of the magnetic layer surface of the magnetic recording medium of the present invention and its opposite surface is preferably not more than 0.5, more preferably not more than 0.3. The surface resistivity is preferably from 10⁴ to 10¹² Ω/sq, the modulus of elasticity at 0.5% elongation of the magnetic layer in both the running direction and the width direction is preferably (100 to 2,000 kg/mm²) and the breaking strength is preferably from 1 to 30 kg/cm². The modulus of elasticity of the magnetic recording medium in both the running direction and the longitudinal direction is preferably from 100 to 1,500 kg/mm² and the residual elongation is preferably not more than 0.5 percent. The thermal shrinkage rate at any temperature not greater than 100° C. is preferably not greater than 1 percent, more preferably not greater than 0.5%, and most preferably not greater than 0.1 percent. The glass transition temperature (i.e., the temperature at which the loss elastic modulus of dynamic viscoelasticity as measured at 110 Hz peaks) of the magnetic layer is preferably not less than 50° C. and not more than 120° C., and that of the lower layer is preferably 0° C.-100° C. The loss elastic modulus preferably falls within a range of from 1 to 8×10⁷ mN/cm² (1×10² to 8×10⁹ dyne/cm²) and the loss tangent is preferably not more than 0.2. Adhesion failure tends to occur when the loss tangent becomes excessively large.

The residual solvent in the magnetic layer is preferably not more than 100 mg/m² and more preferably not more than 10 mg/m². The void ratio in both the lower layer and the magnetic layer is preferably not more than 30 volume percent, more preferably not more than 20 volume percent. Although a low void ratio is preferable for attaining high output, there are some cases in which it is better to ensure a certain level. For example, in magnetic recording media for data recording where repeat applications are important, higher void ratios often result in better running durability. As regards the magnetic characteristics of the magnetic recording medium of the present invention, when measured under a magnetic field of 15.92 KA/m (5 KOe), squareness in the tape running direction is not less than 0.70, preferably not less than 0.80, and more preferably not less than 0.85.

Squareness in the two directions perpendicular to the tape running direction is preferably not more than 80 percent of the squareness in the running direction. The switching field distribution (SFD) of the magnetic layer is preferably not more than 0.6.

The magnetic recording medium of the present invention comprises a lower layer and an upper magnetic layer. It will be readily understood that the physical characteristics of the lower layer and the magnetic layer can be changed based on the objective. For example, the magnetic layer can be imparted with a high modulus of elasticity to improve running durability while at the same time imparting to the lower layer a lower modulus of elasticity than that of the magnetic layer to improve head contact with the magnetic recording medium. What physical characteristics to impart to two or more magnetic layers can be determined by consulting techniques relating to known magnetic multilayers. For example, there are many inventions imparting a higher Hc to the upper magnetic layer than to the lower layer, such as disclosed in Japanese Examined Patent Publication No. Sho 37-2218 and Japanese Un-examined Patent Publication No. Sho 58-56228. However, making the magnetic layer thin as in the present invention permits recording on a magnetic layer of comparatively high Hc.

The present disclosure relates to the subject matter contained in Japanese Patent Application No. 2000-143343, filed on May 16, 2000, which is expressly incorporated herein by reference in its entirety.

Embodiments
The following ferromagnetic metal powders were
employed as the magnetic material.

Ferromagnetic meal powder A:
Co/Fe: 23 atomic percent, Al/Fe: 10 atomic percent,
Y/Fe: 10 atomic percent. Hc: 171,140 A/m (2150 Oe),
major axis length: 0.07 μm, crystal size: 110
Angstrom, pH: 9, acicular ratio: 6.4

| | | |
|---|---|---|
| Abrasive dispersion solution composition: | | |
| α-Al₂O₃ (HIT-60 from Sumitomo | 100 | parts |
| Chemical Industries) | | |
| Vinyl chloride resin (MR-110 from Japan | 10 | parts |
| Zeon) | | |
| Methyl ethyl ketone | 45 | parts |
| Cyclohexanone | 45 | parts |
| Upper layer magnetic layer coating: | | |
| Ferromagnetic metal powder | 100 | parts |
| Polyester polyurethane resin (molecular | 10 | parts |
| weight 35,000, neopentyl | | |
| glycol/caprolactone polyol/MDI = 0.9/2.6/1, | | |
| containing - SO₃Na group 1 × 10⁻⁴ eq/g) | | |
| Phenylphosphonic acid | 5 | parts |
| Carbon black (grain size 0.10 μm) | 0.5 | parts |
| Stearic acid (industrial use) | 1.5 | parts |
| Methyl ethyl ketone | 90 | parts |
| Cyclohexanone | 30 | parts |
| Toluene | 60 | parts |
| Lower layer coating: | | |
| α-Fe₂O₃ | 85 | parts |
| (mean major axis length: 0.1 μm, Sbet: 48 | | |
| m²/g, pH: 8, 1 weight percent of Al₂O₃ per | | |
| total of grains was present on surface) | | |
| Carbon black | 15 | parts |
| Mean primary grain diameter 16 | | |
| nm, DBP oil absorption level 80 | | |
| mL/100 g, pH 8.0, specific | | |
| surface area by BET 250 m²/g, | | |
| volatile matter 1.5 percent | | |
| Vinyl chloride resin (MR-110 from Japan | 7 | parts |
| Zeon) | | |
| Polyester polyurethane resin (molecular | 5 | parts |
| weight 35,000, neopentyl | | |
| glycol/caprolactone polyol/MDI = 0.9/2.6/1, | | |
| containing - SO₃Na group 1 × 10⁻⁴ eq/g) | | |
| Stearic acid | 1 | part |
| Cyclohexanone | 50 | parts |
| Methyl ethyl ketone | 100 | parts |
| Toluene | 50 | parts |

The above-listed abrasive dispersion solution composition was combined and dispersed for 1 hr in a sand grinder filled with zirconium oxide beads to prepare an abrasive dispersion solution.

As regards the upper layer coating composition, the pigment, polyvinyl chloride, phenylphosphonic acid and 50 percent of the quantity of each of the solvents called for in the formula were kneaded in a kneader; and the polyurethane resin, the remaining components, and a quantity of the abrasive dispersion yielding 12.5 weight parts of abrasive in the magnetic material was added. The mixture was mixed in a disperser and dispersed in a sand mill.

To the upper layer dispersion obtained was added 0.6 weight part of sec-butyl stearate (secBS) in Embodiment 1; 1.2 weight parts of secBS in Embodiments 2, 4, and 5 and Comparative Example 5; 1.8 weight parts of secBS in Embodiment 3; 2.4 weight parts of secBS in Comparative Example 2, 1.2 weight parts of isohexadecyl stearate (iHDS) in Comparative Example 3; 1.2 weight parts of pentaerythritol tetrapentanoate (PETP) in Comparative Example 4. In Comparative Example 1, no fatty acid ester was added and 1 part of polyisocyanate (Coronate L from Nippon Polyurethane) was further added. To the lower layer dispersion were added 3 parts of polyisocyanate, 40 parts of a mixed solvent of methyl ethyl ketone and cyclohexanone. And the solutions were filtered with a filter having an average pore diameter of 1 μm to complete preparation of coating solutions for the upper layer coating and the lower layer coating.

The upper layer coating solution and the lower layer coating solution were simultaneously multilayer coated on a PEN film 6 μm in thickness to a lower layer dry thickness of 1.6 μm, and an upper layer dry thickness of 0.06 μM in Embodiments 1-3 and Comparative Examples 1-4, 0.04 μm in Embodiment 4, 0.08 μm in Embodiment 5, and 0.12 μm in Comparative Example 5. While the coated layers were still wet, orientation was conducted with a cobalt magnetic having a magnetic force of 477,600 A/m (6,000 Oersteds) and a solenoid having a magnetic force of 477,600 A/m (6,000 Oersteds).

The Hc values of the magnetic layers of Embodiments 1-5 are given in Table 1.

After drying the upper and lower coating layers, on the reverse surface of the support from the upper and lower coating layers, the backlayer coating described below was applied to a dry backlayer thickness of 0.5 μm. After drying, smoothing was conducted with a seven-stage calender (upper, middle-stage rolls: metal rolls, lower stage flexible rolls: plastic rolls) at 90° C. and a speed of 80 m/min.

| Backlayer Coating | | |
|---|---|---|
| Microgranular carbon black (mean grain | 100 | parts |
| diameter: 17 nm, BP-800 from Cabot) | | |
| Coarse grain carbon black (mean grain | 10 | parts |
| diameter: 270 nm, Thermal Black from | | |
| Kankaib) | | |
| α-Fe₂O₃ | 15 | parts |
| (mean grain diameter 0.11 μm, TF100 from | | |
| Toda Kogyo) | | |
| Nitrocellulose resin | 140 | parts |
| Polyurethane resin | 15 | parts |
| Polyester resin | 5 | parts |
| Polyisocyanate resin | 40 | parts |
| Copper oleate | 5 | parts |
| Copper phthalocyanine | 5 | parts |

The front and back of the magnetic tape obtained in this manner were heated for 48 hours at 70° C. to cure the polyisocyanate compound.

Next, front and back rolls were used to simultaneously remove the edge portions of the front and back sides and cut slits 3.8 mm in width and the magnetic layer surface was cleaned to prepare samples.

(1) Surface Lubricant Index:

The samples were divided into two groups. One group (a) was left untouched. The lubricant component was removed from the other group (b) by the method described below. Both groups of samples were then introduced into an Auger electron spectroscope (model PHI-660) made by the U.S. firm, Φ Company. Under conditions of a primary electron beam acceleration voltage of 3 kV, a sample current of 130 nA, a magnification of 250 times, and an incline angle of 30°, the 730 eV range was integrated three times from a kinetic energy of 130, the intensities of the carbon (C) KLL peak and the iron (Fe) LMM peak were obtained as differential forms, the C/Fe ratio was calculated, and the intensity ratio of (a) to (b) (C/Fe(a)/C/Fe(b)) was calculated as the surface lubricant index.

Method of removing lubricant component: The sample (10 mm×30 mm) was immersed for 30 min at ordinary temperature in n-hexanone and unadsorbed fatty acids and fatty esters were extracted and removed. Next, the samples were placed in test tubes, 10 mL of n-hexanone and 0.3 mL of derivative treatment reagent in the form of the silylating agent TMSI-H (a mixture of hexamethyldisilazalane (HMDS):trimethylchlorosilane (TMCS):pyridine made by Jelu Science Co.) were added, and a derivative treatment reaction was conducted for 1 hr at 60° C. The samples were recovered, washed with ethanol, and dried to complete removal of the lubricant component.

(2) Friction Coefficient

Friction coefficient: The sample tape was wound at a winding angle of 180 degrees on a stainless steel rod (SUS420J) 4 mm in diameter at 23° C. and 70 percent [RH]. The tension (T2) after running 100 passes at a length of 100 mm and a speed of 3.3 cm/sec was measured and the friction coefficient was calculated from the following equation:

Friction coefficient=1/π·ln(T2/T1)

(3) C/N Ratio The C/N ratio was measured using a drum tester. An MIG head with a Bs of 1.5 T and a gap length of 0.15 μm was employed for recording, and an MR head was used for reproduction. The head/medium relative speed during recording and reproduction was 10.5 m/sec, a 21 MHz single frequency signal was recorded, the reproduction spectrum was measured with a spectrum analyzer made by Shibasoku, and the C/N ratio (the ratio of carrier output at 21 MHz to the noise at 19 MHz) was obtained with Comparative Example 5 being 0 dB.

(4) Still Life

Measured in the same manner as the C/N ratio; the time required for the reproduction output to drop 6 dB from the initial output was measured (23° C., 50 percent).

The measurement results are given in Table 1.

TABLE 11

| | | | Thickness of | | | | | |
|---|---|---|---|---|---|---|---|---|
| | Type of | Quantity | Magnetic Layer | Surface | Friction | C/N | | Hc of Magnetic |
| | Lubricant | Added | (μm) | Lubricant Index | Coefficient | (dB) | Still Life | Layer (KA/m) |
| Embodiment 1 | secBS | 0.6 | 0.06 | 1.22 | 0.26 | 2.0 | 50 mm | 184 |
| Embodiment 2 | secBS | 1.2 | 0.06 | 1.74 | 0.27 | 2.4 | >60 mm | 182 |
| Embodiment 3 | secBS | 1.8 | 0.06 | 2.28 | 0.29 | 2.5 | >60 mm | 180 |
| Embodiment 4 | secBS | 1.2 | 0.04 | 1.68 | 0.28 | 2.3 | >60 mm | 181 |
| Embodiment 5 | secBS | 1.2 | 0.08 | 1.80 | 0.28 | 2.0 | >60 mm | 184 |
| Comparative | secBS | 0 | 0.06 | 1.00 | 0.27 | 1.5 | 3 mm | 185 |
| Example 1 | | | | | | | | |
| Comparative | secBS | 2.4 | 0.06 | 2.60 | 0.36 | 2.8 | >60 mm | 178 |
| Example 2 | | | | | | | | |
| Comparative | iHDS | 1.2 | 0.06 | 2.65 | 0.37 | 2.8 | >60 mm | 181 |
| Example 3 | | | | | | | | |
| Comparative | PETP | 1.2 | 0.06 | 1.05 | 0.25 | 2.7 | 5 mm | 181 |
| Example 4 | | | | | | | | |
| Comparative | secBS | 1.2 | 0.12 | 2.00 | 0.29 | 0 | >60 mm | 187 |
| Example 5 | | | | | | | | |

As indicated in Table 1, Embodiments 1-5 all had high C/N ratios and a good still life of 50 minutes, 60 minutes, or more. By contrast, Comparative Examples 1 and 4, with surface lubricant indexes of less than 1. 1, had extremely poor still life and running durability. Comparative Examples 2 and 3, with surface lubricant indexes of 2.4, had high friction coefficients and poor running stability. Comparative Example 5, with a magnetic layer 0.12 μm in thickness, had a poor C/N ratio.

The present invention provides a magnetic recording medium with good running properties, and particularly in recording systems employing MR heads, good stylus characteristics and good electromagnetic characteristics.

What we claim is:

1. A magnetic recording medium which comprises a lower layer comprising a nonmagnetic powder and a binder and a magnetic layer comprising a ferromagnetic powder and a binder provided in this order on a nonmagnetic support, wherein said ferromagnetic powder is a metal ferromagnetic powder with a mean major axis length equal to or less than 0.1 μm, the average thickness of said magnetic layer ranges from 0.01 to 0.1 μm, and the surface lubricant index is 1.1-2.4.

2. The magnetic recording medium according to claim 1 wherein an acicular ratio of said ferromagnetic powder is equal to or more than 5.

3. The magnetic recording medium according to claim 1 wherein a coercivity of said magnetic layer ranges from 2,000 to 3,000 Oe.

4. The magnetic recording medium according to claim 1 wherein said ferromagnetic powder is a metal ferromagnetic powder with a mean major axis length of from 0.04 to 0.09 μm.

5. The magnetic recording medium according to claim 1 wherein the average thickness of said magnetic layer ranges from 0.03 to 0.09 μm.
